(19) United States
(12) Patent Application Publication
(10) Pub. No.: US 2026/0319565 A1
(43) Pub. Date: Oct. 15, 2026

(54) POWER MANAGEMENT CIRCUITRY

(71) Applicant: Arm Limited, Cambridge (GB)

(72) Inventors: Souvik Kumar CHAKRAVARTY, Cambridge (GB); Yie JIA, Winter Springs, FL (US)

(21) Appl. No.: 19/175,352

(22) Filed: Apr. 10, 2025

(51) Int. Cl. G06F 1/3234; G06F 1/3206; G06F 1/324; G06F 1/3287

(52) U.S. Cl. CPC G06F 1/3243; G06F 1/3206; G06F 1/324; G06F 1/3287

(57) ABSTRACT

There is provided an apparatus, a system, a chip-containing product, a method, and a computer-readable medium. The apparatus comprises processing circuitry configured to perform processing operations, the processing circuitry configured to operate in a plurality of power modes ranging from a highest performance mode to a lowest performance mode. The apparatus comprises monitoring circuitry configured to monitor at least one utilisation property of the processing circuitry. The apparatus comprises power management circuitry configured to receive preference information indicative of a subset of the plurality of power modes, to perform a selection of a power mode from the subset based on the at least one utilisation property, and to control the processing circuitry to operate in the power mode.

### TECHNICAL FIELD

The present invention relates to data processing. More particularly the present invention relates to an apparatus, a system, a chip-containing product, a method, and a computer-readable medium.

### BACKGROUND

Some apparatuses are provided with power management circuitry to select a power mode and to cause processing circuitry to operate in the selected power mode.

### SUMMARY

According to a first aspect of the present techniques there is provided an apparatus comprising:
processing circuitry configured to perform processing operations, the processing circuitry configured to operate in a plurality of power modes ranging from a highest performance mode to a lowest performance mode;
monitoring circuitry configured to monitor at least one utilisation property of the processing circuitry; and
power management circuitry configured to receive preference information indicative of a subset of the plurality of power modes, wherein the subset is a proper subset, to perform a selection of a power mode from the subset based on the at least one utilisation property, and to control the processing circuitry to operate in the power mode.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method comprising:
performing, with processing circuitry, processing operations, the processing circuitry configured to operate in a plurality of power modes ranging from a highest performance mode to a lowest performance mode;
monitoring at least one utilisation property of the processing circuitry; and
receiving preference information indicative of a subset of the plurality of power modes, wherein the subset is a proper subset;
performing a selection of a power mode from the subset based on the at least one utilisation property; and
controlling the processing circuitry to operate in the power mode.

According to a fifth aspect of the present techniques there is provided a non-transitory computer-readable medium storing computer-readable code for fabrication of an apparatus comprising:
processing circuitry configured to perform processing operations, the processing circuitry configured to operate in a plurality of power modes ranging from a highest performance mode to a lowest performance mode;
monitoring circuitry configured to monitor at least one utilisation property of the processing circuitry; and
power management circuitry configured to receive preference information indicative of a subset of the plurality of power modes, wherein the subset is a proper subset, to perform a selection of a power mode from the subset based on the at least one utilisation property, and to control the processing circuitry to operate in the power mode

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates a plurality of power modes according to some configurations of the present techniques;

FIGS. 4a and 4b schematically illustrate an example selection of a power mode according to some configurations of the present techniques;

FIGS. 5a and 5b schematically illustrate an example selection of a power mode according to some configurations of the present techniques;

FIGS. 6a and 6b schematically illustrate an example selection of a power mode according to some configurations of the present techniques;

FIGS. 7a and 7b schematically illustrate an example selection of a power mode according to some configurations of the present techniques;

FIG. 8 schematically illustrates an apparatus according to some configurations of the present techniques;

FIG. 9a schematically illustrates an apparatus according to some configurations of the present techniques;

FIG. 9b schematically illustrates an apparatus according to some configurations of the present techniques;

FIG. 10a schematically illustrates a sequence of steps carried out according to some configurations of the present techniques;

FIG. 10b schematically illustrates a sequence of steps carried out according to some configurations of the present techniques;

FIG. 10c schematically illustrates a sequence of steps according to some configurations of the present techniques; and

FIG. 11 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising processing circuitry configured to perform processing operations, the processing circuitry configured to operate in a plurality of power modes ranging from a highest performance mode to a lowest performance mode. The apparatus is provided with monitoring circuitry configured to monitor at least one utilisation property of the processing circuitry. The apparatus is provided with power management circuitry configured to receive preference information indicative of a subset of the plurality of power modes, wherein the subset is a proper subset, to perform a selection of a power mode from the subset based on the at least one utilisation property, and to control the processing circuitry to operate in the power mode.

The apparatus is provided with processing circuitry that is operable in a plurality of different power modes. The power modes each have different performance and/or power consumption characteristics and range from a highest performance mode to a lowest performance mode. The highest performance mode is the mode of the plurality of power modes that offers the best potential performance, e.g., in terms of instructions processed per unit time, or in terms of a number of a particular type of instruction processed per unit time. The lowest performance mode is the mode of the plurality of power modes that offers the lowest performance, e.g., in terms of instructions processed per unit time. Whilst the plurality of modes may include only two power modes, i.e., the lowest performance mode and the highest performance mode, in some configurations, the plurality of power modes may include a far greater range of modes each offering a different power consumption and/or performance. The power modes are arranged in a sequence from the highest performance mode, typically corresponding to a highest power consumption, down to a lowest performance mode, typically corresponding to a lowest power consumption.

Whilst the highest performance power mode offers the highest potential performance, the achieved performance will depend on the particular use case. For example, during a period of relatively low utilisation, a same performance may be observed (measured) for the highest performance power mode and a lower performance power mode. However, the power consumed by the processing circuitry operating at the highest performance power mode may exceed the power consumed by the processing circuitry operating at the lower performance power mode. This may be, for example, due to additional micro-architectural features (such as branch prediction circuitry and/or prefetch circuitry) that are enabled in the higher performance mode but, due to the particular use case, do not provide significant (or any) performance benefits. Alternatively, this may be due to additional cores being powered on that, due to the particular use case, do not receive a sufficient number of instructions to result in any appreciable increase in performance. In such cases, the higher performance mode may use more power than the lower performance mode without providing any performance benefit. Similarly, the lowest performance mode may, due to the particular use case, not provide an appreciable power saving, but may result in an overall reduced performance. As used herein, the terms highest performance power mode and lowest performance mode are to be interpreted as the power modes which, respectively, offer the highest potential performance and the lowest potential performance.

Theoretically, there are a number of different ways in which a power mode could be selected. For example, the power mode could be selected by a user, e.g., via higher privileged software such as an operating system or hypervisor. This approach could provide an additional level of control to a programmer or compiler and could be used to dynamically select an appropriate power mode in advance of a particular set of instructions being executed. For example, where the programmer or compiler knows that an upcoming set of instructions may require relatively high computing resources, a more performant power mode could be selected in advance of the upcoming set of instructions being executed to improve performance. Alternatively, the power mode could be selected based on one or more utilisation properties of the processing circuitry. This approach shifts the burden of selecting the power mode away from the software and allows the power mode to be selected based on the computational load seen by the processing circuitry during runtime. Whilst this approach ties the power mode more closely to the current computational load, it means that the power mode selection is changed in response to the type of load rather than providing the ability for the power mode to be selected pre-emptively.

The inventors have recognised that both of these possible approaches can be advantageous in different use cases. The apparatus is therefore provided with monitoring circuitry configured to monitor at least one utilisation property of the processing circuitry. The apparatus is also provided with power management circuitry that receives the utilisation property and that receives preference information indicative of a preferred subset of the plurality of power modes. The power management circuitry is configured to select the power mode from the subset based on the utilisation information. In other words, the plurality of power modes from which the power mode is selected is restricted such that power modes, other than the power modes in the subset, are excluded from being selected. This approach enables a preference to be specified, e.g., by a user via higher privileged software, but also affords the power management circuitry the freedom to select a power mode from the preferred subset based on the runtime conditions for a given processing load. Advantageously, the combination of these features enables user preferences to be respected and for the preferred mode to be modified based on runtime conditions which may either not be known a-priori and/or may differ from expected runtime conditions.

The subset is a proper subset, i.e., it defines a number of modes of the plurality of power modes that is less than a total number of modes in the plurality of power modes. In other words, the subset excludes at least one of the plurality of power modes, thereby reducing the number of modes from which the power mode can be selected.

The minimum number of power modes that are included in the subset can be variously defined. In some configurations the power management circuitry is responsive to the preference information meeting at least one predetermined condition, to determine, as the subset, two or more of the plurality of power modes. The predetermined condition may be a requirement on preference information, e.g., that the subset specification in the preference information identifies two or more power saving modes. In such configurations, the power management circuitry selects the power mode from the two or more of the plurality of modes based on the utilisation property.

Alternatively, or in addition, in some configurations the power management circuitry is responsive to the preference information not meeting the at least one predetermined condition, to determine, as the subset, a single one of the plurality of power modes. As discussed, the predetermined condition may be a condition relating to the preference information and the predetermined condition may be not met when the preference information indicates a single one of the plurality of power modes. In other words, the preference information may identify the number of power modes that are incorporated in the subset. When a single one of the plurality of power modes is included in the subset, the power management circuitry is configured to select the single one of the plurality of power modes as the power mode.

The preference information can take a variety of forms and in some configurations the preference information comprises a preferred power mode identifying a specific one of the plurality of power modes to be included in the subset. The power management circuitry may be arranged to favour the specific one of the plurality of power modes. For example, the power management circuitry may require that an alternative power mode, included in the subset and different from the preferred power mode, offers a reduction in power consumption, e.g., a reduction in power consumption greater than a predefined threshold, with minimal or no loss of performance for the current set of instructions, e.g., a performance loss that is less than a predefined performance loss threshold.

In some configurations the preference information comprises range information restricting a number of power modes by which the selection is permitted to deviate from the preferred power mode. For example, the preference information may be one or more pieces of information including the range information and the preferred power mode. The range information may be specified as a number of power modes which indicates the number of power modes by which the selected power mode can differ from the preferred power mode. The range information may be provided as a single number or as a pair of numbers, e.g., a first number indicating a number of more performant power modes included in the subset and a second number indicating a number of less performant power modes included in the subset. The range may be provided explicitly, i.e., as a binary encoded number indicating the number of modes by which the power mode can deviate from the preferred power mode. Alternatively, the range may be calculated based on the preferred power mode and one or more other range identifying numbers such that the amount by which the power mode can deviate from the preferred power mode is dependent on the preferred power mode.

In some example configurations the plurality of power modes may be specified by an Operating Preference Point (OPP) value as defined in the System Control and Management Interface (SCMI) protocol. The range information may be specified as an Energy Defined Performance (EDP) value of the SCMI protocol. Whilst an EDP value would typically, where specified, be interpreted as a preferred OPP value with the absolute decision on the power mode being dependent on the utilisation information, in the current techniques the EDP value is interpreted as providing the range information as defined above. The EDP as interpreted by the power management circuitry according to the current techniques therefore restricts the power management circuitry from selecting one or more OPP values that fall outside of the subset. The preferred power mode may be specified as a SCMI Desired Performance (SCMI_DP) value. Typically, the SCMI_DP value, where specified, would overwrite any decision made by power management circuitry causing the power mode to be the specified SCMI_DP value. However, according to the present techniques the SCMI_DP value is interpreted as a preferred mode by the power management circuitry which can be modified based on the specified EDP value. The SCMI protocol therefore allows for a utilisation information driven mode in which any OPP can be selected or a SCMI_DP driven mode in which the OPP is specified by software. The techniques described herein utilise these parameters, however, the power management circuitry interprets the parameters in an entirely different way with additional control being provided to allow a user, e.g., via privileged software, to have control over the power modes being selected, but to enable the power management circuitry to adapt (modify) the preferred power mode within a restricted subset of power modes based on the range information.

In some configurations the preferred power mode identifies an extremum of the subset. The subset may be defined by the preferred power mode as one extremum (e.g., a maximum or a minimum) and the range information identifying the other extremum (e.g., the other one of the maximum or the minimum). For example, the preference information may include, e.g., as the range information, a signed binary number which is added to the preferred power mode to obtain a second extremum. For example, if the preferred power mode is mode x and the range information is y, then the power mode is selected from the subset of power modes ranging from x to x-y for negative y, and from x-y to x for positive y. Where x is equal to zero, then the subset contains a single power mode and the power control circuitry is configured to select power mode x regardless of the utilisation information.

In some configurations a quantity of the plurality of power modes included in the subset is dependent on the preferred power mode. In other words, where the preference information identifies a preferred power mode and a range, the range may be interpreted differently dependent on the preferred power mode.

The preference information can be identified to the power control circuitry in a variety of ways. In some configurations the processing circuitry comprises decoder circuitry responsive to a power mode selection instruction identifying the preference information, to trigger the power management circuitry to perform the selection. Decoder circuitry is provided as part of processing circuitry to receive and decode instructions from an Instruction Set Architecture (ISA). The ISA comprises a comprehensive set of instructions that can be used by a programmer or compiler to control the processing circuitry. The instruction decoder receives instructions and, based on those instructions issues control signals that cause the processing circuitry and additional circuitry, such as the power management circuitry to behave in a particular way. The power mode selection instruction may be an instruction of the ISA and can be used to provide the programmer or compiler with control over the power mode. The power mode selection instruction may identify, as operands, the preferred power mode and range information indicative of the subset. In some configurations, the power mode selection instruction may be restricted such that it can only be executed by privileged software having a privilege level above a predefined threshold. For example, the power mode selection instruction may require an operating system or a hypervisor to issue the instruction.

Furthermore, in some configurations the apparatus comprises a control register accessible to the privileged software, wherein the power management circuitry is configured to retrieve the preference information from the control register. The control register is accessible to the power management circuitry and is also accessible to at least some software, e.g., higher privileged software being executed on the processing circuitry. The control register may be specifiable as an output register in one or more instructions such that standard ISA instructions can be utilised to modify the value in the control registers. Alternatively, or in addition, the control register may be accessed using the power mode selection instruction which writes to the control register.

In some configurations each of the plurality of power modes identify at least one of: a frequency of operation of the processing circuitry; a quantity of active compute units; and a number of active communication channels. Typically, a processing circuitry operating at a higher frequency will have a greater instruction throughput per second but will also consume more power. Similarly, having a greater number of active compute units will result in a greater instruction throughput per second and per cycle, but will require additional power. Furthermore, having a greater number of communication channels, e.g., I/O channels available can result in an increased instruction throughput at increased power consumption. Typically, the plurality of power modes will be preprogramed into the power control circuitry and arranged from a most performant power mode to a least performant power mode either during the manufacture of the apparatus or according to a specific firmware implementation on the apparatus. The plurality of power modes may therefore be arranged as a consecutive sequence with one or more of the identified performance parameters being adjusted between power modes.

Whilst the subset may be explicitly indicated in the preference information, in some configurations the subset is determined from the preference information based on a mapping function. For example, the mapping function may be provided as a linear or non-linear function, or a series of lookup tables that determines the subset based on the provided preference information.

In some configurations the mapping function is hard wired into the power management circuitry. For example, the mapping function can be determined at the time of manufacture. Alternatively, in some configurations the mapping function is configurable. For example, the apparatus may be provided with one or more ISA instructions that enable modification of the mapping function under the control of privileged software. Alternatively, or in addition, the mapping function may be based on one or more functions implemented in firmware. In some configurations the power management circuitry configured to receive the preference information from higher privileged software.

In some configurations the plurality of power modes is a contiguous set of power modes and the subset is a contiguous subset of the contiguous set of power modes. Defining a contiguous subset of the power modes enables a relatively compact form of preference information to be used. In some alternative configurations the subset may comprise a non-contiguous set of the plurality of power modes providing greater flexibility to the higher privileged software. For example, in some configurations, the power control circuitry is responsive to preference information indicating a particular type of power mode, to exclude power modes other than the particular type of power mode. For example, the preference information may specify that the subset should include (or exclude) only power modes in which a maximum number of cores are utilised and the power management circuitry is configured to make the selection of the power mode from that subset of the plurality of power modes.

Particular configurations will now be described with reference to the figures.

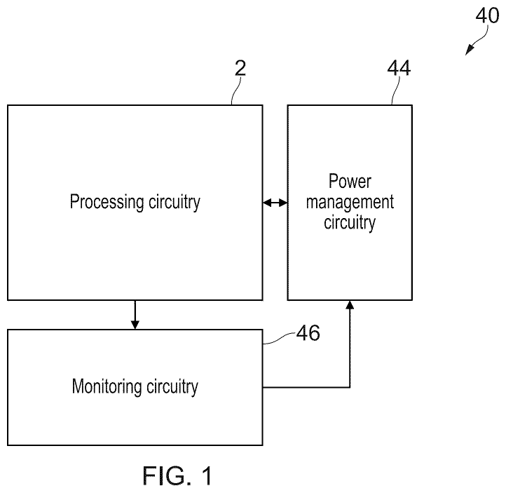

FIG. 1 schematically illustrates an apparatus 40 according to some configurations of the present techniques. The apparatus 40 comprises processing circuitry 2, power management circuitry 44, and monitoring circuitry 44. The processing circuitry 2 is arranged to perform processing operations in response to instructions, for example, instructions specified as part of an ISA. The processing circuitry 2 is operable in a plurality of different power modes ranging from a highest performance power mode to a lowest performance power mode.

The monitoring circuitry 46 is configured to monitor the processing circuitry to determine at least one utilisation based parameter, for example, the monitoring circuitry 46 may monitor a number of instructions issued for execution, a number of a particular type of instruction issued for execution, a number of instructions that trigger a particular functional unit of the processing circuitry, etc. The monitoring circuitry 46 monitors the utilisation property over a monitoring window. The monitoring window may last for a predetermined amount of time, a predetermined number of instructions, or a predetermined number of a particular type of instruction.

The power management circuitry 44 is configured to select the power mode in which the processing circuitry 2 operates. The power management circuitry 44 determines the power mode based on preference information received, e.g., from the processing circuitry. The preference information determines a subset of power modes from which the power mode is to be selected. The power management circuitry 44 determines the power mode from the subset based on the utilisation property that is monitored by the monitoring circuitry 46. As a result, the power mode of the processing circuitry is dependent on both of the preference information and the utilisation property.

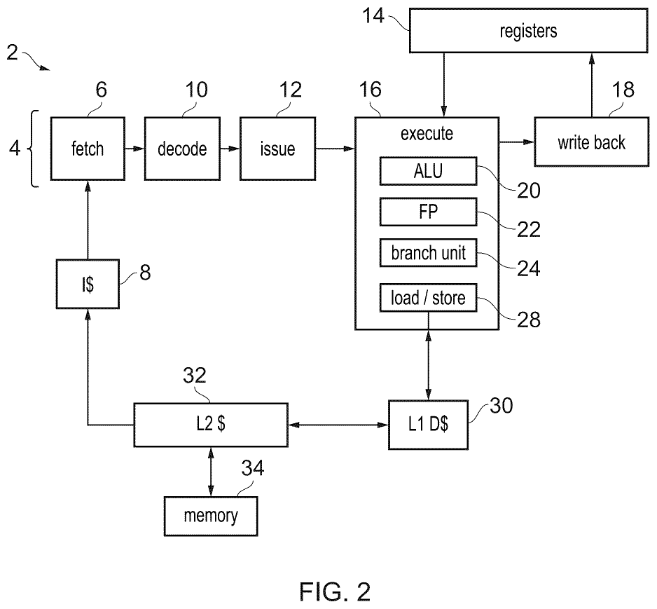

FIG. 2 schematically illustrates an example of processing circuitry 2 according to some configurations of the present techniques. The processing circuitry 2 has a processing pipeline 4 which includes a number of pipeline stages. In this example, the pipeline stages include a fetch stage 6 for fetching instructions from an instruction cache 8; a decode stage 10 for decoding the fetch program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example, in an out-of-order processor an additional register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system include a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 2 is merely a simplified representation of some components of possible processing circuitry, and the processing circuitry may include many other elements not illustrated for conciseness, such as branch prediction mechanisms or address translation or memory management mechanisms.

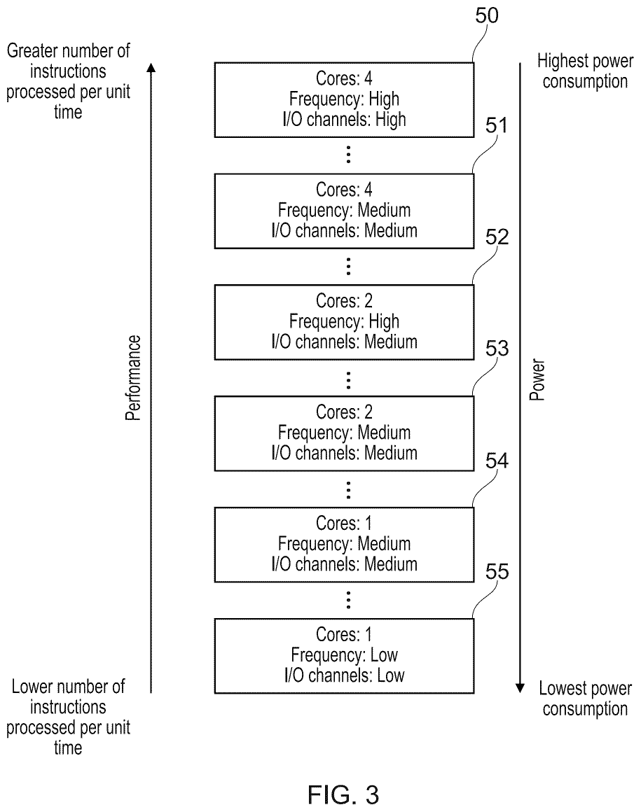

FIG. 3 schematically illustrates a plurality of power modes in which the processing circuitry 2 may be operated. The plurality of processing modes includes a most performant (highest performance) processing mode 50, ranging to a least performant (lowest performance) mode 58. The highest performance mode 50 typically provides a highest power consumption and the lowest performance mode 58 typically provides the lowest power consumption.

The plurality of power modes includes the highest performance power mode 50 in which four cores are active, the frequency at which the processing circuitry is operated is high, and the number of I/O channels used is high. The plurality of power modes includes a second highest performance power mode 51 in which four cores are active, the frequency at which the processing circuitry is operated is medium and a medium number of I/O channels is used. The plurality of power modes also includes a third highest performance power mode 52 in which two cores are active, the frequency at which the processing circuitry is operated is high and a medium number of I/O channels is used. The plurality of power modes also includes a fourth highest performance power mode 53 in which two cores are active, the frequency at which the processing circuitry is operated is medium and a medium number of I/O channels is used. The plurality of power modes also includes a fifth highest performance power mode 54 in which one core is active, the frequency at which the processing circuitry is operated is medium and a medium number of I/O channels is used. The plurality of power modes also includes a sixth highest performance power mode 55 (the lowest performance mode) in which one core is active, the frequency at which the processing circuitry is operated is low and a low number of I/O channels is used.

It will be readily apparent to the person skilled in the art that the power modes may identify further features of the processing circuitry, such as a portion of space in one or more caches that is available, whether an out-of-order core is available, whether branch prediction structures and/or prefetching structures are enabled. In general, the power modes identify micro-architectural features which can be turned on or off to provide different performance characteristics and/or different power consumption characteristics. In the illustrated example, six different power modes are illustrated, however, it will be readily apparent to the skilled person that any number of power modes could be included in the plurality of power modes.

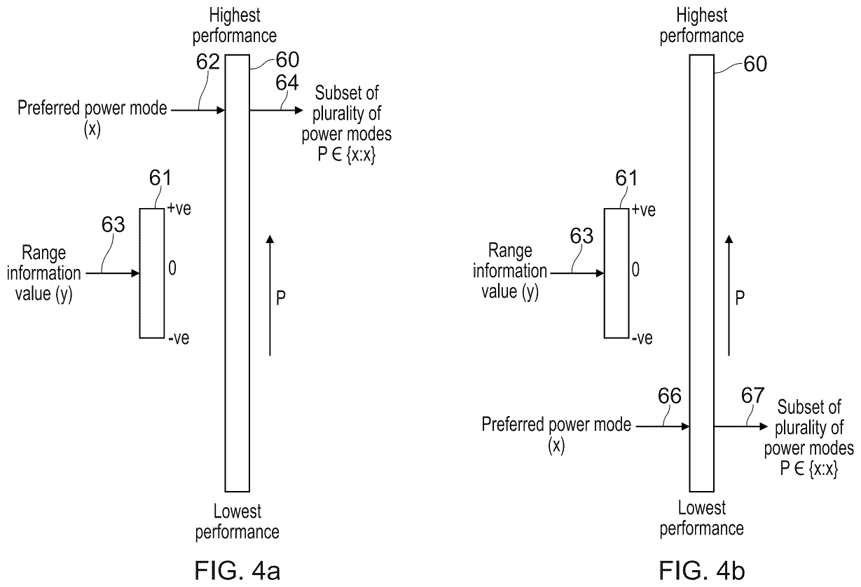

FIGS. 4-7 schematically illustrate a series of examples in which preference information, in the form of a preferred power mode and range information is provided and a subset of the plurality of power modes are identified. In each of the figures, the plurality of power modes 60 is identified as a range from a highest performance power mode (typically the highest power consumption mode) to a lowest performance power mode (typically the lowest power consumption mode). The preferred power mode in each example is indicated as one of the plurality of power modes 60. The range information is indicated by a single value out of a range of possible values 61 ranging from a maximum possible value to a minimum possible value.

FIGS. 4a and 4b schematically illustrate a pair of examples in which a range information value 63 (y) is provided midway through the possible range values 61 (P), i.e., y=0. FIG. 4a illustrates an example in which a preferred power mode 62 (x) is indicated as being closer to the highest performance power mode of the plurality of power modes 60. The power management circuitry 44 receives the range information value 63 and the preferred power mode 62 and identifies a subset 64 of the plurality of power modes 60. Because y is equal to zero, the range comprises the single power mode (x) as the preferred power mode 62, in other words, the subset comprises values P∈{x:x}, i.e., power modes P that belong to the range from x to x.

FIG. 4b schematically illustrates a further example in which a preferred power mode 65 is indicated as being closer to the lowest performance power mode of the plurality of power modes 60. As in FIG. 4a, the range information value 63 (y ) is provided midway through the possible range values 61 (y=0). The power management circuitry 44 receives the range information value 63 and the preferred power mode 66 (x) and identifies a subset 67 of the plurality of power modes 60 comprising the single power mode (x) indicated as the preferred power mode 66. Because y is equal to zero, the range comprises the single power mode (x) as the preferred power mode 62, in other words, the subset comprises values P∈{x:x}, i.e., power modes P that belong to the range from x to x.

In FIGS. 4a and 4b, the range information value 63 causes the power management circuitry 44 to define a narrow subset comprising the preferred power mode (x) only. The management circuitry 44 therefore selects the preferred power mode as the power mode and causes the processing circuitry 2 to operate in the power mode. The interpretation of the range information value 63 in this way by the management circuitry allows the preference information to explicitly specify the power mode.

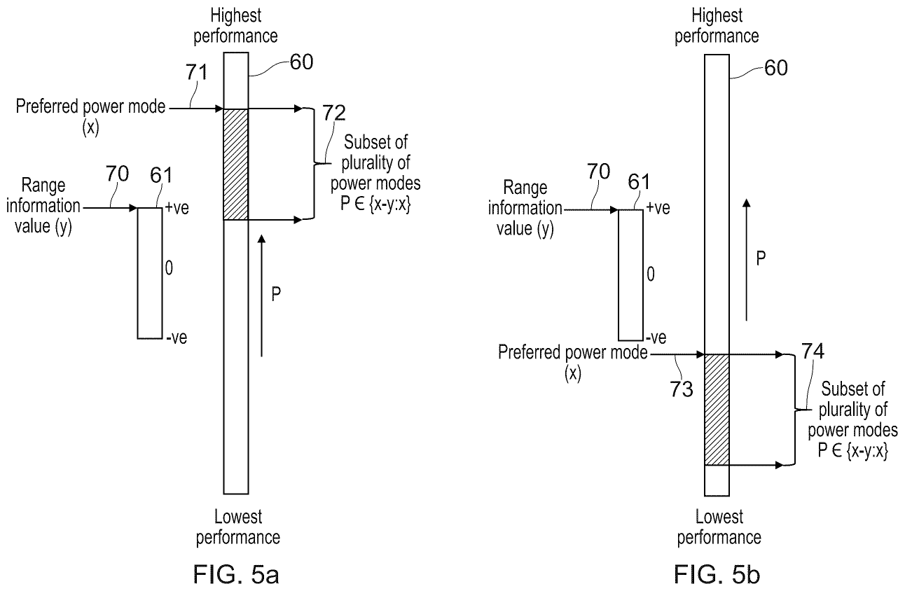

FIGS. 5a and 5b schematically illustrate a further pair of examples in which a range information value 70 (y) is provided as a maximum possible one of the possible range values 61. FIG. 5a illustrates an example in which a preferred power mode 71 (x) is indicated as being closer to the highest performance power mode of the plurality of power modes 60. The power management circuitry 44 receives the range information value 70 and the preferred power mode 71 and identifies a subset 72 of the plurality of power modes 60 comprising the power mode indicated as the preferred power mode 71 and a plurality of lower performance power modes. Because y is positive, the range comprises power modes in the range from x-y to x, in other words, the subset comprises values P∈{x-y:x}, i.e., power modes P that belong to the range from x-y to x. The power management circuitry 44 then determines the power mode from the subset 72 of the plurality of power modes 60 and causes the processing circuitry 2 to operate in the selected power mode.

FIG. 5b schematically illustrates a further example in which a preferred power mode 73 (x) is indicated as being closer to the lowest performance power mode of the plurality of power modes 60. As in FIG. 5a, the range information value 70 (y ) is provided as a maximum possible one of the possible range values 61. The power management circuitry 44 receives the range information value 70 and the preferred power mode 73 and identifies a subset 74 of the plurality of power modes 60 comprising the power mode indicated as the preferred power mode 73 and a plurality of lower performance power modes. Because y is positive, the range comprises power modes in the range from x-y to x, in other words, the subset comprises values P∈{x-y:x}, i.e., power modes P that belong to the range from x-y to x. The power management circuitry 44 then determines the power mode from the subset 74 of the plurality of power modes 60 and causes the processing circuitry 2 to operate in the selected power mode.

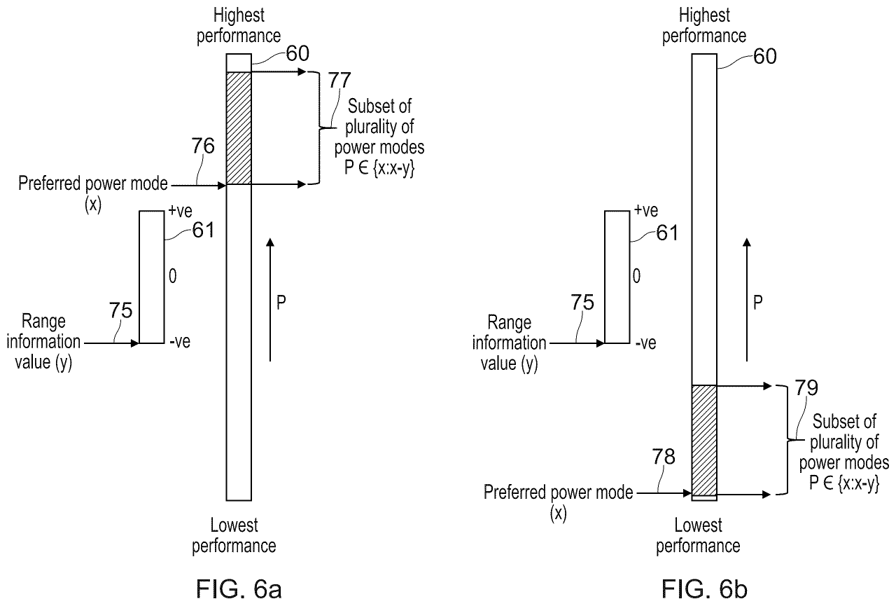

FIGS. 6a and 6b schematically illustrate a further pair of examples in which a range information value 75 (y) is provided as a minimum possible one of the possible range values 61. FIG. 6a illustrates an example in which a preferred power mode 76 (x) is indicated as being closer to the highest performance power mode of the plurality of power modes 60. The power management circuitry 44 receives the range information value 75 and the preferred power mode 76 and identifies a subset 77 of the plurality of power modes 60 comprising the power mode indicated as the preferred power mode 76 and a plurality of higher performance power modes. Because y is negative, the range comprises power modes in the range from x to x-y, in other words, the subset comprises values P∈{x:x-y}, i.e., power modes P that belong to the range from x to x-y. The power management circuitry 44 then determines the power mode from the subset 77 of the plurality of power modes 60 and causes the processing circuitry 2 to operate in the selected power mode.

FIG. 6b schematically illustrates a further example in which a preferred power mode 78 (x) is indicated as being closer to the lowest performance power mode of the plurality of power modes 60. As in FIG. 6a, the range information value 75 (y ) is provided as a minimum possible one of the possible range values 61. The power management circuitry 44 receives the range information value 75 and the preferred power mode 78 and identifies a subset 79 of the plurality of power modes 60 comprising the power mode indicated as the preferred power mode 78 and a plurality of higher performance power modes. Because y is negative, the range comprises power modes in the range from x to x-y, in other words, the subset comprises values P∈{x:x-y}, i.e., power modes P that belong to the range from x to x-y. The power management circuitry 44 then determines the power mode from the subset 79 of the plurality of power modes 60 and causes the processing circuitry 2 to operate in the selected power mode.

It will be readily apparent to the person of ordinary skill in the art that the determination of the subset from the preferred power mode (x) and the range information value (y) need not be defined using the linear relationship set out in FIGS. 4 to 6. Similarly, the range of values for y may not range from negative to positive and could take only positive values (or only negative values). For example, the upper and lower bounds of the subset could be computed such that the preferred value falls within the range of the subset, i.e., P ranges from x−y/2 to x+y/2 for positive y. As a second example, rather the range over which y is defined need not be from a negative value to a positive value. Rather, the value y may range from 0 to Y, e.g., 0 to 2^{N}−1 where N is an integer with P taking values of x+A(y−2^{N-1}) where A is a scaling constant which may be less than 1. As a third example, the bounds could be determined by using a mathematical function f(x,y) for a lower bound and g(x,y) for an upper bound. The mathematical functions may be linear, or non-linear functions. As a further example, one or more lookup tables could be used to determine the values for the subset bounds based on a combination of x and y.

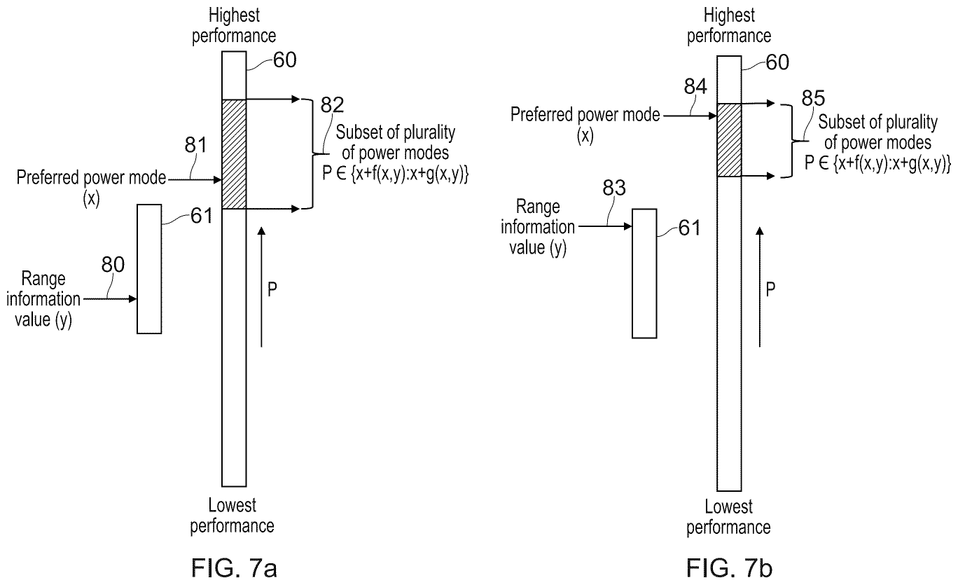

FIGS. 7a and 7b schematically illustrate a further pair of examples in which a range information value 80 (y) is provided at a point within the range of possible range values 61 closer to the minimum of the range 61 than to the maximum of the range 61. FIG. 7a illustrates an example in which a preferred power mode 81 (x) is indicated as being closer to the highest performance power mode of the plurality of power modes 60. The power management circuitry 44 receives the range information value 80 and the preferred power mode 81 and identifies a subset 82 of the plurality of power modes 60 comprising the power mode indicated as the preferred power mode 81 and a plurality of other power modes including some higher performance power modes and some lower performance power modes. Because the range value information is indicated closer to the minimum of the range 61, the subset 82 comprises a greater number of power modes that are more performant than the preferred power mode and a smaller number of power modes that are less performant than the preferred power mode. In the illustrated configurations the bounds of the subset are determined based on mathematical functions f(x,y) and g(x,y). As such, the total number of power modes included in the subset may be dependent on both x and y. Hence, the range comprises power modes in the range from x+f(x,y) to x+g(x,y), in other words, the subset comprises values P∈{x+f(x,y):x+g(x,y)}, i.e., power modes P that belong to the range from x+f(x,y):x to g(x,y). The power management circuitry 44 then determines the power mode from the subset 82 of the plurality of power modes 60 and causes the processing circuitry 2 to operate in the selected power mode.

FIG. 7b schematically illustrates a further example in which a preferred power mode 83 (x) is indicated as being closer to the lowest performance power mode of the plurality of power modes 60. The range information value 83 (y) is provided as a point in the range of possible range values 61 closer to the maximum of the range 61 than to the minimum of the range 61. The power management circuitry 44 receives the range information value 83 and the preferred power mode 84 and identifies a subset 85 of the plurality of power modes 60 comprising the power mode indicated as the preferred power mode 84 and a plurality of other power modes including some higher performance power modes and some lower performance power modes. Because the range value information is indicated closer to the maximum of the range 61, the subset 85 comprises a greater number of power modes that are less performant than the preferred power mode and a smaller number of power modes that are more performant than the preferred power mode. In the illustrated configurations the bounds of the subset are determined based on mathematical functions f(x,y) and g(x,y). As such, the total number of power modes included in the subset may be dependent on both x and y. Hence, the range comprises power modes in the range from x+f(x,y) to x+g(x,y), in other words, the subset comprises values P∈{x+f(x,y):x+g(x,y)}, i.e., power modes P that belong to the range from x+f(x,y):x to g(x,y). The power management circuitry 44 then determines the power mode from the subset 85 of the plurality of power modes 60 and causes the processing circuitry 2 to operate in the selected power mode. Because the values of x and y in FIG. 7b are different from those illustrated in FIG. 7a, the upper and lower bounds of the subset 85 differ. Furthermore, the number of values included in the subset 85 is dependent on the values of x and y and therefore differs between FIGS. 7a and 7b.

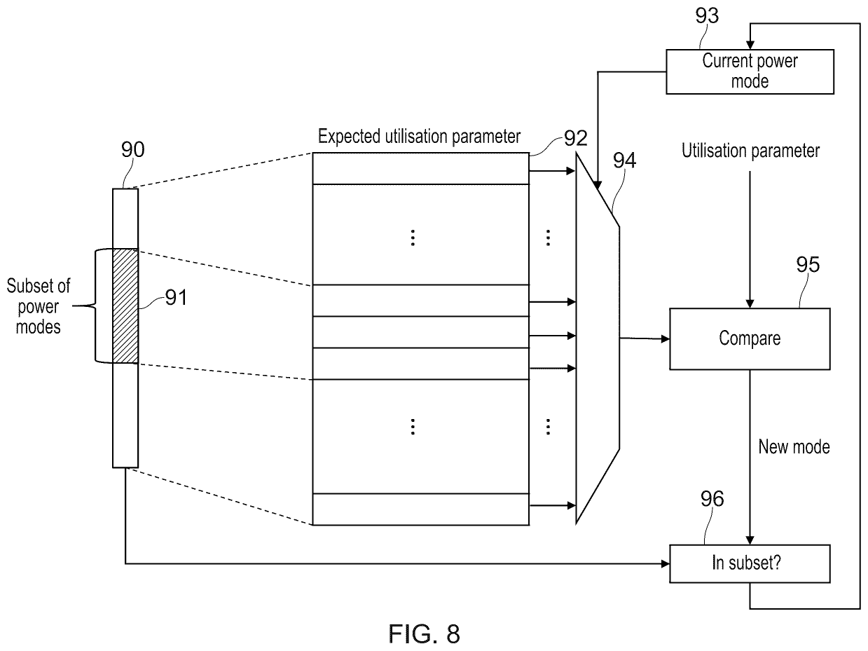

FIG. 8 schematically illustrates an example determination of a current power mode 93 from the subset 91 of the plurality of power modes 90. The power management circuitry 44 stores expected parameter information 92 for each of the plurality of power modes 90. The power management circuitry receives a measured utilisation parameter from monitoring circuitry 46 and compares the utilisation parameter against expected parameter information 92 for the current power mode 93. The utilisation parameter is selected using selection circuitry 92. The expected parameter information and the utilisation parameter are compared using comparison circuitry 95 which outputs a suggested new mode. The suggested new mode may be a specific indication of a suggested power mode or an indication of an increment by which to change the power mode. The suggested new mode is passed to subset comparison circuitry 96 which determines if the suggested new mode falls within the subset. If the suggested new mode falls within the subset, then the current power mode 93 is updated. If the suggested new mode does not fall within the subset, then the power management circuitry 44 retains the current power mode. In some alternative configurations, if the suggested new mode does not fall within the subset, then the power management circuitry 44 selects, as the new power mode, a power mode from within the subset that is closest to the suggested new mode.

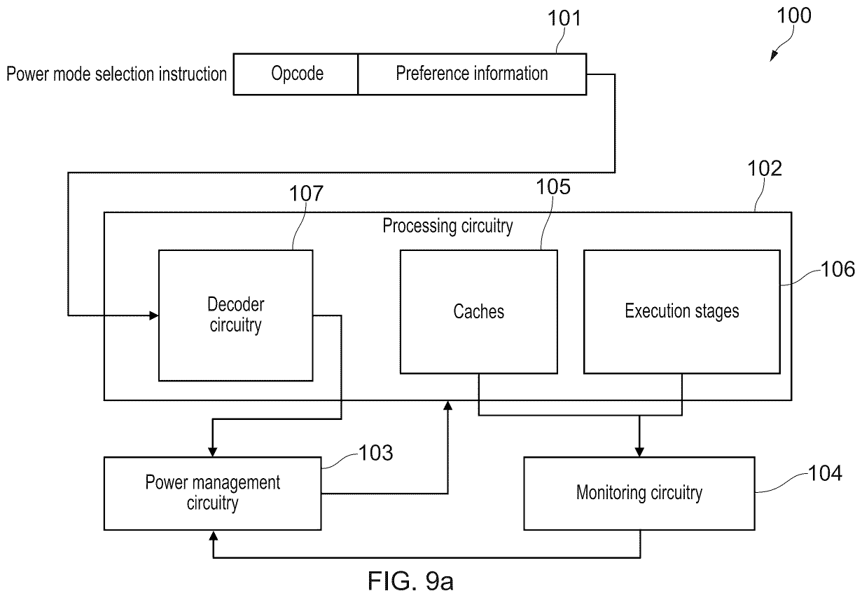

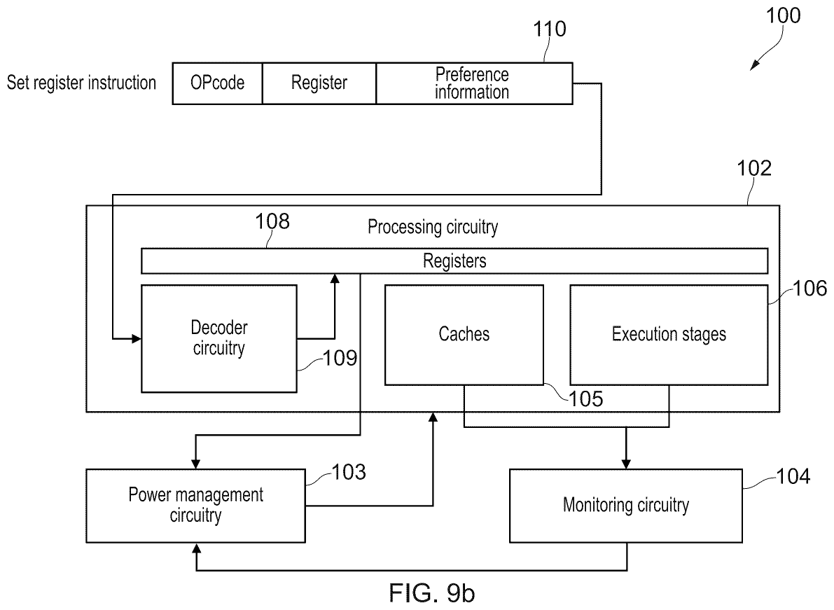

FIG. 9a schematically illustrates an apparatus 100 according to some configurations of the present techniques. The apparatus 100 is provided with processing circuitry 102, monitoring circuitry 104, and power management circuitry 103. The processing circuitry 102 is provided with decoder circuitry 107 one or more caches 105 and one or more execution stages 106. The decoder circuitry is configured to receive instructions and to decode those instructions in order to generate control signals to be provided to control the execution stages to perform processing operations defined in those instructions. The processing circuitry 102 is operable in a plurality of power modes under the control of the power management circuitry 103.

As described above, the power management circuitry 103 is configured to receive preference information and utilisation information and, based on the received information, to select a power mode and to cause the processing circuitry 102 to operate in that mode. The utilisation information is provided to the power management circuitry 103 by the monitoring circuitry 104 which monitors utilisation information in relating to the processing circuitry 102. For example, the monitoring circuitry 104 may monitor a frequency of utilisation of one or more execution stages 106 and a utilisation of the one or more caches.

The decoder circuitry 107 is responsive to a power mode selection instruction comprising an opcode and preference information, to generate control signals to cause the preference information to be signalled to the power management circuitry 103. The power management circuitry 103 receives the preference information and the utilisation information and selects a power mode from a subset of the plurality of possible modes. The subset of the plurality of possible modes is identified from the preference information.

FIG. 9b schematically illustrates the apparatus 100 according to some configurations of the present techniques. In addition, or as an alternative to the mechanism for setting providing the preference information to the power management circuitry 103, the decoder circuitry is responsive to one or more instructions that cause a value in a register to be set. A number of the features of the FIG. 9b are the same as the features of FIG. 9a and the description of these features is omitted for conciseness.

The set register instruction 110 may be, for example, a move instruction to move an immediate value into a register or a specific instruction provided as part of the ISA for the purpose of controlling the power management circuitry. The set register instruction 110 comprises an opcode to identify the instruction, a register specifier, and preference information. The set register instruction 110 is received by the decoder circuitry 109 which is configured to cause the processing circuitry 102 to modify a value in one of a plurality of registers 108 specified in the set register instruction 110. The set register instruction may include a specific register identifier to identify a control register accessible to the power management circuitry 103. The power management circuitry reads the control register, e.g., by continuously polling the control register, and determines the subset from the preference information. The utilisation information is provided to the power management circuitry 103 as described in relation to FIG. 9a and the power management circuitry is configured to set the power state of the processing circuitry 102 based on the utilisation information and the subset defined by the preference information.

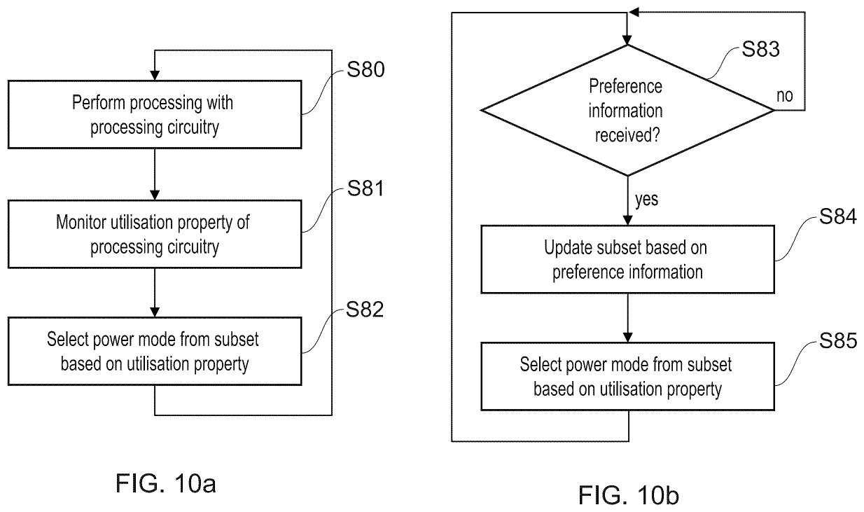

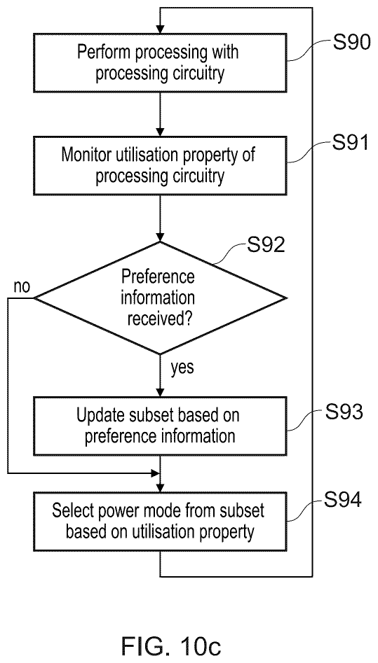

FIGS. 10a and 10b schematically illustrates sequences of steps carried out according to some configurations of the present techniques. FIG. 10a schematically illustrates a sequence of steps carried out by the power management circuitry to select a power mode from amongst a plurality of power modes in response to monitoring of a utilisation property of the processing circuitry. Flow begins at step S80 where processing is performed with the processing circuitry 2 operating in one of a plurality of possible power modes. Flow then proceeds to step S81 where a utilisation property of the processing circuitry is monitored. Flow then proceeds to step S82 where a power mode is selected from a subset based on the utilisation property. Flow then returns to step S80.

FIG. 10b schematically illustrates a sequence of steps carried out by the power management circuitry to select a power mode from amongst the plurality of power modes in response to receipt of preference information. Flow begins at step S83 where it is determined whether preference information has been received. If, at step S83, it is determined that preference information has not been received, then flow remains at step S83. If, at step S83, it is determined that preference information has been received, then flow proceeds to step where the subset is updated based on the preference information. For example, the subset may be determined as described in relation to FIGS. 4 to 7. Flow then proceeds to step S85 where a power mode is selected from the subset based on the utilisation property. Flow then returns to step S83.

FIG. 10c schematically illustrates a sequence of steps carried out by power management circuitry to select a power mode from amongst the plurality of power modes in response to receipt of preference information. It is assumed that, prior to the flow being initialised, a subset is initially defined, for example, by a hardwired defined default value or based on a firmware specified value loaded when the system is initialised. Flow begins at step S90 where processing is performed with processing circuitry. Flow then proceeds to step S91 where a utilisation property of the processing circuitry is monitored. Flow then proceeds to step S92 where it is determined whether preference information has been received, e.g., from software being executed on the processing circuitry. If, at step S92, it is determined that preference information has not been received, then flow proceeds to step S94 which will be described below. If, at step S92, it is determined that preference information has been received, then flow proceeds to step S93 where the subset is updated based on the preference information. Flow then proceeds to step S94 where a power mode is selected from the subset based on the utilisation property. Flow then returns to step S90.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

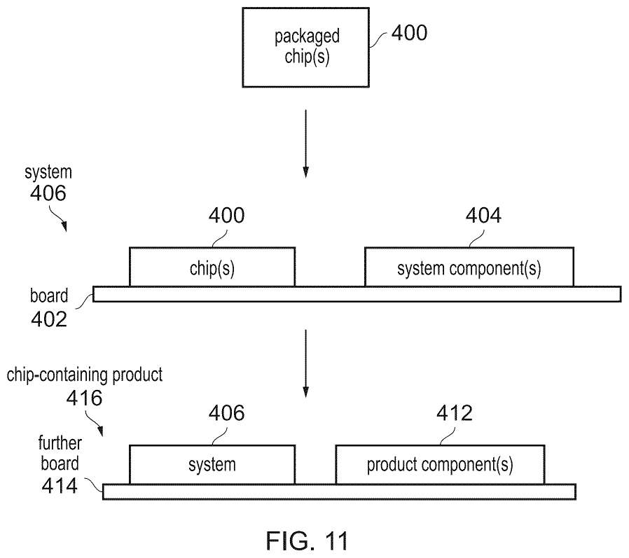

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus, a system, a chip-containing product, a method, and a computer-readable medium. The apparatus comprises processing circuitry configured to perform processing operations, the processing circuitry configured to operate in a plurality of power modes ranging from a highest performance mode to a lowest performance mode. The apparatus comprises monitoring circuitry configured to monitor at least one utilisation property of the processing circuitry. The apparatus comprises power management circuitry configured to receive preference information indicative of a subset of the plurality of power modes, to perform a selection of a power mode from the subset based on the at least one utilisation property, and to control the processing circuitry to operate in the power mode.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
processing circuitry configured to perform processing operations, the processing circuitry configured to operate in a plurality of power modes ranging from a highest performance mode to a lowest performance mode;
monitoring circuitry configured to monitor at least one utilisation property of the processing circuitry; and
power management circuitry configured to receive preference information indicative of a subset of the plurality of power modes, wherein the subset is a proper subset, to perform a selection of a power mode from the subset based on the at least one utilisation property, and to control the processing circuitry to operate in the power mode.

Clause 2. The apparatus of clause 1, wherein the subset excludes at least one of the plurality of power modes.

Clause 3. The apparatus of clause 1 or clause 2, wherein the power management circuitry is responsive to the preference information meeting at least one predetermined condition, to determine, as the subset, two or more of the plurality of power modes.

Clause 4. The apparatus of clause 3, wherein the power management circuitry is responsive to the preference information not meeting the at least one predetermined condition, to determine, as the subset, a single one of the plurality of power modes.

Clause 5. The apparatus of any preceding clause, wherein the preference information comprises a preferred power mode identifying a specific one of the plurality of power modes to be included in the subset.

Clause 6. The apparatus of clause 5, wherein the preference information comprises range information restricting a number of power modes by which the selection is permitted to deviate from the preferred power mode.

Clause 7. The apparatus of clause 5 or clause 6, wherein the preferred power mode identifies an extremum of the subset.

Clause 8. The apparatus of any of clauses 5 to 7, wherein a quantity of the plurality of power modes included in the subset is dependent on the preferred power mode.

Clause 9. The apparatus of any preceding clause, wherein the processing circuitry comprises decoder circuitry responsive to a power mode selection instruction identifying the preference information, to trigger the power management circuitry to perform the selection.

Clause 10. The apparatus of any preceding clause, comprising a control register accessible to the privileged software, wherein the power management circuitry is configured to retrieve the preference information from the control register.

Clause 11. The apparatus of any preceding clause, wherein each of the plurality of power modes identify at least one of:
a frequency of operation of the processing circuitry;
a quantity of active compute units; and
a number of active communication channels.

Clause 12. The apparatus of any preceding clause, wherein the subset is determined from the preference information based on a mapping function.

Clause 13. The apparatus of clause 12, wherein the mapping function is hard wired into the power management circuitry.

Clause 14. The apparatus of clause 12, wherein the mapping function is configurable.

Clause 15. The apparatus of any preceding clause, wherein the plurality of power modes is a contiguous set of power modes and the subset is a contiguous subset of the contiguous set of power modes.

Clause 16. The apparatus of any preceding clause, wherein the power management circuitry configured to receive the preference information from higher privileged software.

### Clause 17. a System Comprising:

the apparatus of any preceding clause, implemented in at least one packaged chip;
at least one system component; and
a board,
wherein the at least one packaged chip and the at least one system component are assembled on the board.

Clause 18. A chip-containing product comprising the system of clause 17, wherein the system is assembled on a further board with at least one other product component.

Clause 19. A method comprising:
performing, with processing circuitry, processing operations, the processing circuitry configured to operate in a plurality of power modes ranging from a highest performance mode to a lowest performance mode;
monitoring at least one utilisation property of the processing circuitry; and
receiving preference information indicative of a subset of the plurality of power modes, wherein the subset is a proper subset;
performing a selection of a power mode from the subset based on the at least one utilisation property; and
controlling the processing circuitry to operate in the power mode.

Clause 20. A non-transitory computer-readable medium storing computer-readable code for fabrication of the apparatus of any of clauses 1 to 16.

We claim:

1. An apparatus comprising:
processing circuitry configured to perform processing operations, the processing circuitry configured to operate in a plurality of power modes ranging from a highest performance mode to a lowest performance mode;
monitoring circuitry configured to monitor at least one utilisation property of the processing circuitry; and
power management circuitry configured to receive preference information indicative of a subset of the plurality of power modes, wherein the subset is a proper subset, to perform a selection of a power mode from the subset based on the at least one utilisation property, and to control the processing circuitry to operate in the power mode.

2. The apparatus of claim 1, wherein the power management circuitry is responsive to the preference information meeting at least one predetermined condition, to determine, as the subset, two or more of the plurality of power modes.

3. The apparatus of claim 2, wherein the power management circuitry is responsive to the preference information not meeting the at least one predetermined condition, to determine, as the subset, a single one of the plurality of power modes.

4. The apparatus of claim 1, wherein the preference information comprises a preferred power mode identifying a specific one of the plurality of power modes to be included in the subset.

5. The apparatus of claim 4, wherein the preference information comprises range information restricting a number of power modes by which the selection is permitted to deviate from the preferred power mode.

6. The apparatus of claim 4, wherein the preferred power mode identifies an extremum of the subset.

7. The apparatus of claim 4, wherein a quantity of the plurality of power modes included in the subset is dependent on the preferred power mode.

8. The apparatus of claim 1, wherein the processing circuitry comprises decoder circuitry responsive to a power mode selection instruction identifying the preference information, to trigger the power management circuitry to perform the selection.

9. The apparatus of claim 1, comprising a control register accessible to the privileged software, wherein the power management circuitry is configured to retrieve the preference information from the control register.

10. The apparatus of claim 1, wherein each of the plurality of power modes identify at least one of:
a frequency of operation of the processing circuitry;
a quantity of active compute units; and
a number of active communication channels.

11. The apparatus of claim 1, wherein the subset is determined from the preference information based on a mapping function.

12. The apparatus of claim 11, wherein the mapping function is hard wired into the power management circuitry.

13. The apparatus of claim 11, wherein the mapping function is configurable.

14. The apparatus of claim 1, wherein the plurality of power modes is a contiguous set of power modes and the subset is a contiguous subset of the contiguous set of power modes.

15. The apparatus of claim 1, wherein the power management circuitry configured to receive the preference information from higher privileged software.

16. The apparatus of claim 1, wherein the subset excludes at least one of the plurality of power modes.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
performing, with processing circuitry, processing operations, the processing circuitry configured to operate in a plurality of power modes ranging from a highest performance mode to a lowest performance mode;
monitoring at least one utilisation property of the processing circuitry; and
receiving preference information indicative of a subset of the plurality of power modes, wherein the subset is a proper subset;
performing a selection of a power mode from the subset based on the at least one utilisation property; and
controlling the processing circuitry to operate in the power mode.

20. A non-transitory computer-readable medium storing computer-readable code for fabrication of an apparatus comprising:
processing circuitry configured to perform processing operations, the processing circuitry configured to operate in a plurality of power modes ranging from a highest performance mode to a lowest performance mode;
monitoring circuitry configured to monitor at least one utilisation property of the processing circuitry; and
power management circuitry configured to receive preference information indicative of a subset of the plurality of power modes, wherein the subset is a proper subset, to perform a selection of a power mode from the subset based on the at least one utilisation property, and to control the processing circuitry to operate in the power mode.
